(19) United States
(12) Patent Application Publication
(10) Pub. No.: US 2001/0001855 A1
(43) Pub. Date: May 24, 2001

(54) Method of conducting a political convention

(76) Inventor: Witold A. Ziarno, Chicago, IL (US)

Correspondence Address: Witold A. Ziarno, 4519 S. St. Louis, Chicago, IL, 60632, US

(21) Appl. No.: 09/728,454

(22) Filed: Dec. 1, 2000

Related U.S. Application Data
(62) Division of application No. 09/173,109, filed on Oct. 15, 1998.

(51) Int. Cl. G06F 17/60

(52) U.S. Cl. 705/39; 705/64; 705/35

(57) ABSTRACT

A fund-raising computer network and method for simplifying and inducing the giving of monetary contributions by a multiplicity of prospective contributors consisting of a computer with communication circuitry for communicating over a computer network data sets comprised of requests soliciting the making of monetary contributions to a plurality of remote prospective contributors' computers and, a means for receiving data sets comprised of contributions from the remote contributors' respective computers communicated over a computer network. The network and method induces and simplifies the making of contributions. Contributions include political contributions, charitable contributions, and religious contributions. Requests for contributions include multi-media presentations communicated to prospective contributors' computers which are networked to computer networks.

### BACKGROUND

### Technical Field

This invention relates generally to a computer network for fund-raising and method of fund-raising; and, more particularly, it relates to a computer network for fund-raising and method of fund-raising by way of a single or a plurality of computer networks in which a message requesting or soliciting the making of contributions is communicated onto a computer network(s) to a multiplicity of remote prospective contributors' computers, and, in response to the fund-raising request, the contributors communicate contributions onto the computer network(s).

As is well known, fund-raising organizations are typically assisted in the solicitation of contributions through the use of pledges, and the like. A contributor is requested to make a pledge, and then later to honor the pledge by payment of the amount pledged. A problem with this type of fund-raising is that a number of pledges do not get honored. Some contributors forget about their pledge. Moreover, the contributor's financial situation may have changed between the making of a pledge and the honoring the pledge so that he no longer has adequate funds, even though the contributor had adequate funds available at the time a pledge was made. In any event, in such situations fund raising organizations lose pledged contributions.

Further, known methods by which a contributor makes a contribution allow for the external stimulus that induces the making of a contribution to dissipate before the contribution is consummated. With respect to pledges, known pledging methods remove the consummation of the contribution process in time and space from the point where an external stimulus for inducing the making of a contribution is exerted on a contributor or an group of contributors. The problem of removing the consummation of the contribution process in time and space from the point of exertion of maximum stimulus, is that the impulse to make a contribution decays and dissipates over time. As the impulse dissipates over time a contributor is less likely to consummate the contribution or less likely to contribute a larger contribution than he or she would otherwise if the consummation of the contribution process were to occur near the point of maximum stimulation to make a contribution.

By way of example, where a fund-raiser solicits a pledge from a contributor the solicitation and pledge commitment is usually made during a point of maximum stimulus exerted on the prospective contributor by a fund-raiser or by an event. However, a pledge commitment is generally honored at a time and place remote from the time and place the pledge commitment was made. The result is that fund-raisers are usually required to make several follow-ups solicitations in order to consummate the contribution, e.g. actually get the contributor to fill out a check in the amount of the contribution, and mail the check to the fund-raising organization. Since the contributor has at this point been far separated from the external stimulus applied to make the contribution, the impulse to make a contribution has decayed and dissipated, and it is more difficult to consummate the contribution. Their exists a need for a method of facilitating, consummating, and inducing a monetary contribution that allows the contribution to be consummated at a time and place where the impulse or external stimulus creating the impulse is greatest to make a contribution is greatest.

Further, most methods of fund-raising require that a plurality of contributors are gathered in the same physical location to have a contribution session. The present invention provides a fund-raising computer network that creates a contribution session with a plurality or multiplicity of remote contributors located in different geographical locations in a variant.

Fund-raisers are faced with limited resources that include man-power resources, and other tangible resources. By way of example, assuming that a fund-raising organization has a plurality of simultaneous events competing for man-power, a fixed group of resources with which to gather and solicit contributions, and a scenario where it would be logistically impossible to service all of the competing events, a fund-raising organization must allocate its resources in such a way as to maximize the contributions over the competing events. There exists a need for a fund-raising network and method of fund-raising that will maximize the quantity and size of contributions and not require a number of competing events to be staged for fund-raising.

Similarly, assuming that a fund-raising organization has a multiplicity of prospective contributors at a single event, a fixed group of resources with which to gather and solicit contribution transactions at a single event and a limited amount of time during which to gather contributions, and a scenario where it would be logistically impossible to solicit all of the prospective contributors at a single event, a fund-raising organization must allocate its resources in such a way as to maximize the contributions during the single event. There exists a need for a fund-raising network and method of fund-raising that will maximize the quantity and size of contributions and will allow a multiplicity of contributors to be solicited for contributions.

It would be highly desirable to solve the variety of problems enumerated above facing fund-raisers, and members of fund-raising organizations in soliciting contributions made by information bearing cards or debited from accounts.

It is an object of the present invention to provide a fund-raising method and fund-raising computer network that can collect, analyze, and display statistical information associated with a contribution or a plurality of respective contributions and provide useful quantitative data.

### SUMMARY OF THE INVENTION

The present invention provides a fund-raising network, system and method for simplifying and inducing the giving of monetary contributions by a multiplicity of prospective contributors. The system and network include a computer with communication circuitry for communicating over a computer network requests soliciting the making of monetary contributions to a plurality of remote prospective contributors' computers; and, a means for receiving contributions from the remote contributors' respective computers communicated over a computer network. In variants, the contributions include respective contributor cardholder information correlated to numeric contribution amounts, cybercash, information representative of electronic currency, and combinations thereof.

The system, network, and method includes optionally encryption of the contributions. The monetary contributions include, by way of example, a political contribution, a charitable contribution, and a religious contribution. The request includes text, or a multi-media presentation. These and other objects will become apparent in the detailed description of the invention.

### BRIEF DESCRIPTION OF THE DRAWINGS

FIG. 1 illustrates a diagram of a method of the present invention.

FIG. 1a illustrates a diagram of a variant of a method of the present invention including an optional encryption step.

FIG. 1b illustrates a diagram of a system and network of the present invention.

FIG. 1c illustrates a diagram of a network of interconnected computer networks of the present invention.

FIGS. 2 and 2a illustrate exemplary requests of the present invention.

FIG. 3 illustrates a schematic block diagram of a fund-raiser's computer of the present invention, a network of interconnected computers, and prospective contributor's computers.

FIG. 4 illustrates a formula for contribution potential.

FIG. 4a illustrates a formula of the present invention.

FIG. 4b illustrates formulas showing the dissipation of the contribution potential as a function of stimulus and time.

### DETAILED DESCRIPTION OF THE PREFERRED EMBODIMENTS

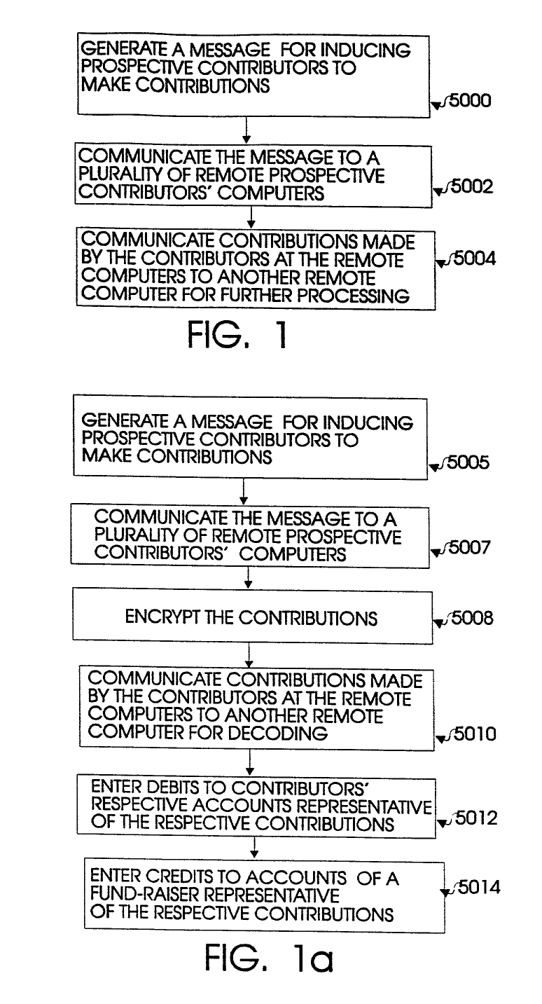

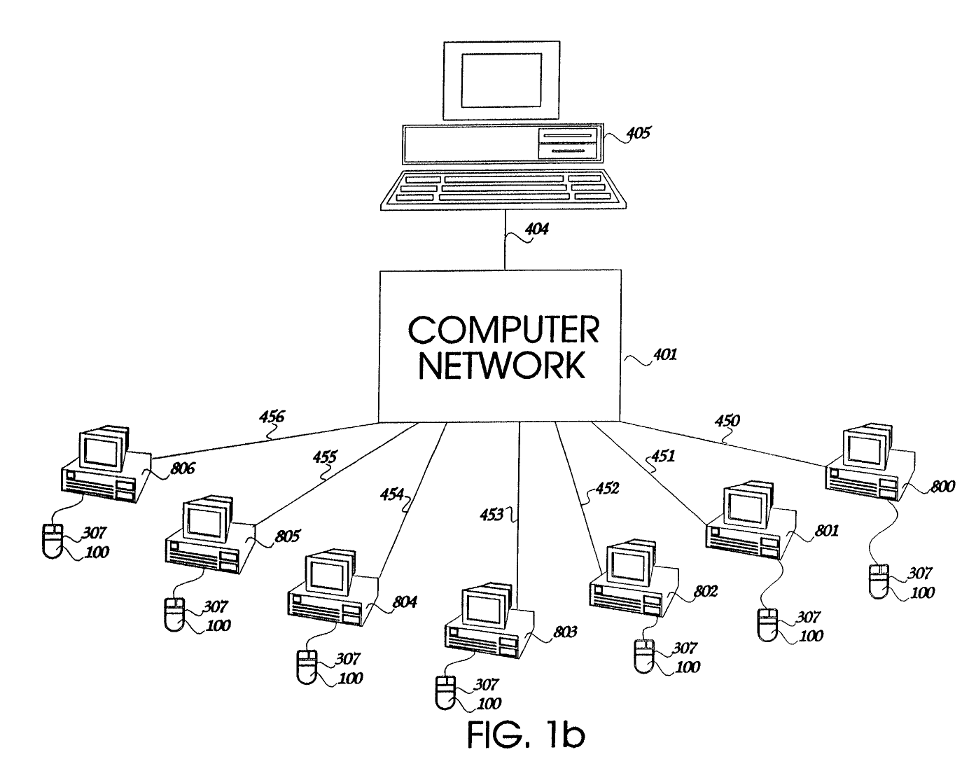

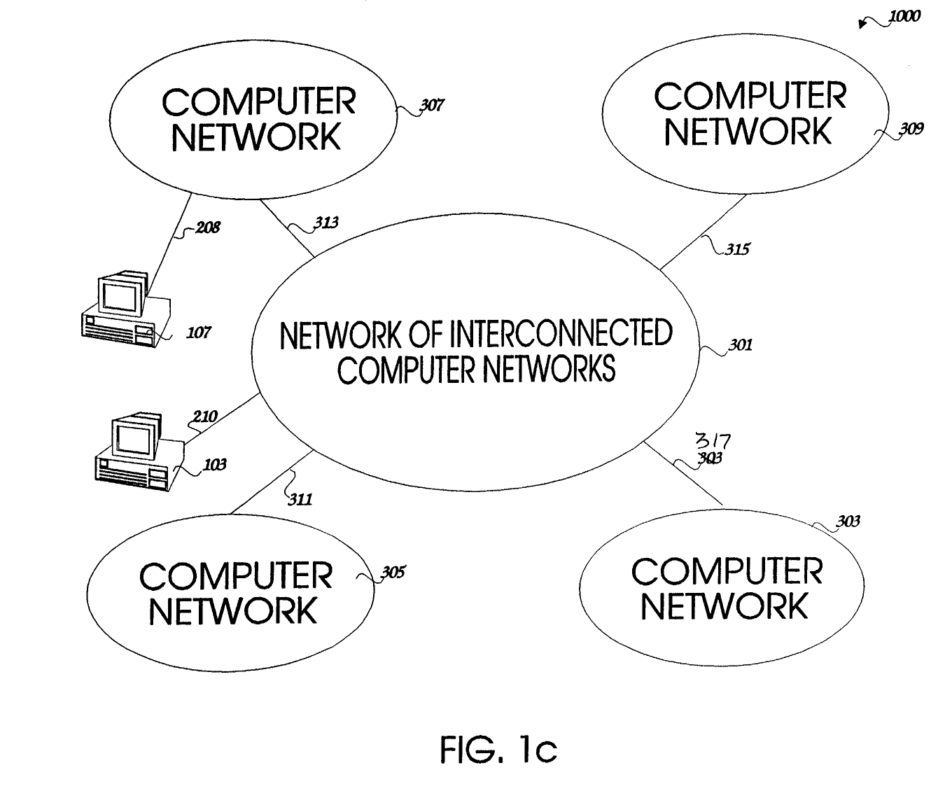

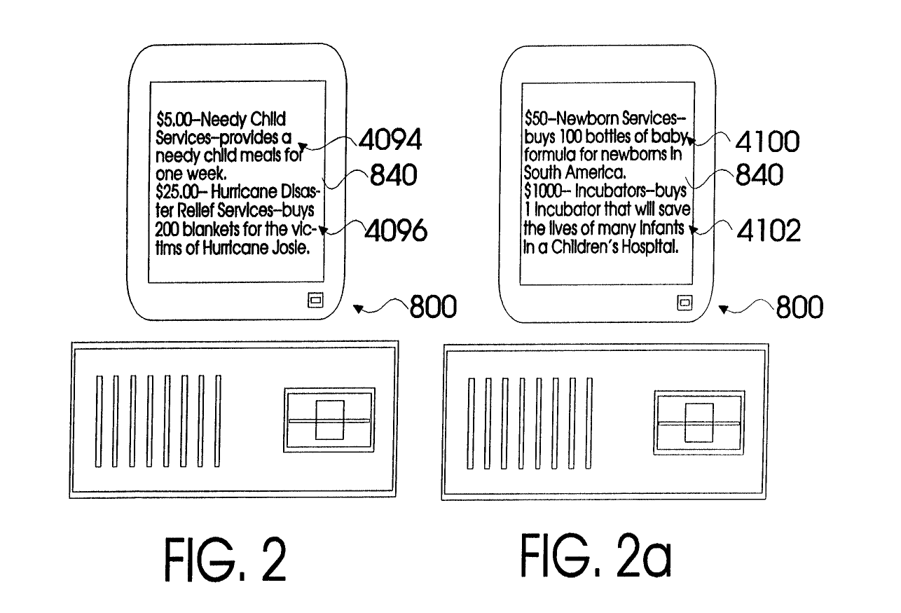

By way of example and as illustrated in FIG. 1, a fund-raiser generates a message or request 5000 for inducing prospective contributors to make contributions. The message 5000 is transmitted from computer 405 along communication link 404 to computer network 401 so that it reaches respective remote prospective contributors' computers 800-806 (FIG. 1b). Numerals 450-456 indicate respective communication links linking computers 800-806 to computer network 401. Hence, message 5000 is communicated to respective remote contributors' computers 800-806 as indicated in step 5002. Prospective contributors' computers 800-806 display message 5000 on displays 840 to the respective contributors (FIGS. 2 and 2a).

FIG. 1c illustrates a web of interconnected computer networks 1000 used in fund-raising methods and fund-raising network and system of the invention. By way of further example, computer network 301 is a worldwide computer network of computer networks. By way of example, network 301 is the Internet in a variant. Network 301 comprises local area networks, metropolitan area networks, and wide area networks. Network 301 connects computers of organizations and individuals globally in a variant. The networks that comprise networks 301, 305, 307, 309, and 401 are communicatively linked together by way of communication links, e.g. 404, 450-456, 311, 313, 315, 317. These communication links and others described herein comprise, by way of example, dialup phone lines, high-speed dedicated leased lines, satellites, fiber optic communication links, microwave communication links, and/or wireless satellite communication links and combinations thereof. Network 301 communicatively connects computers nationally and/or globally.

The computers on network 301 communicate using various protocols. Exemplary protocols include DECnet, Novell, Appletalk, SNA, TCP/IP(Transmission Control Protocol/Internet Protocol), Open Systems Interconnection protocol, etc. TCP/IP applications include electronic mail (“email”), remote login, and file transfer.

The email application is used to create and communicate a fund-raising message or request to a plurality or multiplicity of computers 103, 800-806 of prospective contributors. For example, a fund-raiser who, for example is a monk, in Austria sends a fund-raising email request to a computer of a philanthropist in New York. In a variant a monk in Austria sends a fund-raising email request to a plurality or multiplicity of computers at businesses in America, Europe, Asia, and Australia.

Exemplary displays are illustrated in FIGS. 2 and 2a. Display 4094 displays exemplary messages 4094, 4096, 4100, 4102 for inducing the making of a monetary contribution by the respective contributors.

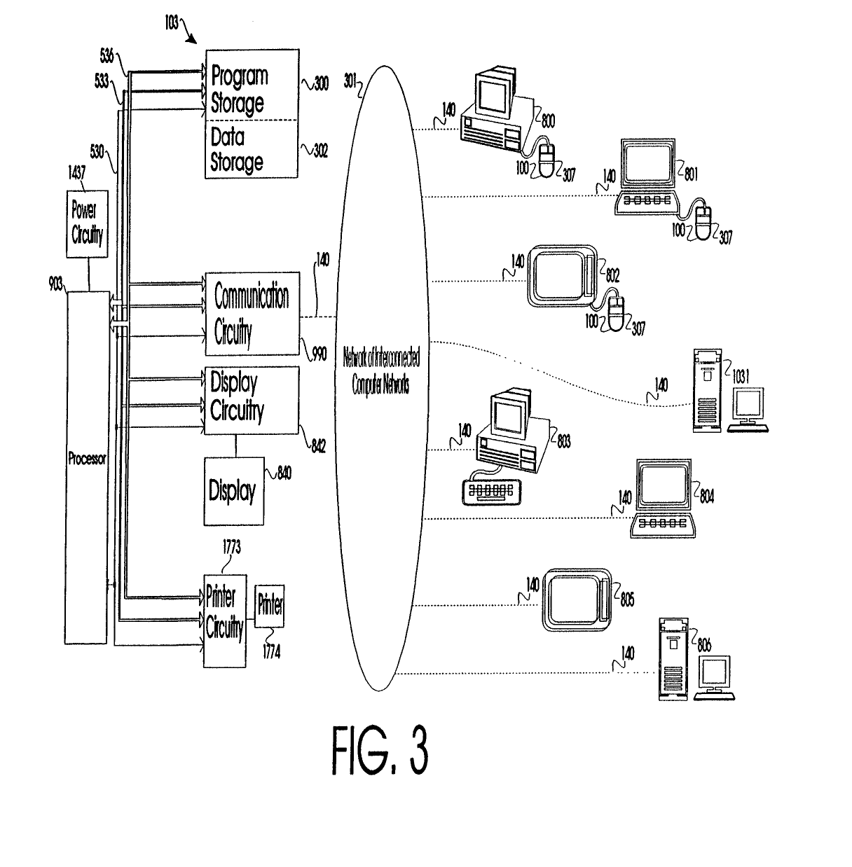

The file transfer application allows a fund-raiser to transfer files from fund-raiser's computer 103 along communication link 210 (FIG. 1c), or along communication link 140 (FIG. 3) to the network of interconnected computer networks 301.

Fund-raiser's computer 103 and remote prospective contributors' computers 800-806 (FIG. 1c and FIG. 3) and remote prospective contributor's computer 107 includes processing circuitry 903. In the present embodiment, processing circuitry includes a microprocessor. However, multiple microprocessors, or a plurality of dedicated microprocessors may also so used. Processing circuitry 903 and associated circuitry are powered through power source 1437. Processing circuitry 903 interfaces with associated circuitry via an address bus 536, data bus 533, and control bus 530.

A variety of links and associated circuitry are used in the present invention. Byway of example, link 140 (FIG. 3) links 404, 450-456 (FIG. 1b), and links 311, 313, 315, 317 (FIG. 1c) are serial links and associated circuitry in one variant, RS 232 links and associated circuitry in another embodiment, modem circuitry in communication with circuitry 990 (FIG. 3) in yet another embodiment, or RF or infra-red links and associated circuitry in yet another variant.

A variety of additions can be added to the embodiment of processing circuitry 903. By way of example, communication circuitry 990, display 840 and related circuitry 840, and a printer 1774 and printer circuitry 1773 can be added. Files that are transferred include documents, graphics, or multimedia requests for a contribution. A file also comprises an audio portion, visual portion, or combination thereof.

When a fund-raiser (meaning a fund-raiser or person or entity acting on behalf of a fund-raiser) uses the above referenced applications he transfers exemplary fund-raising request or message 4094, 4096, 4100, 4102 (FIGS. 2 and 2a), or files representative of indicia requesting a contribution from computer 103 to remote prospective contributor's computer 107 (FIG. 1c), or to a plurality of remote prospective contributors' computers on network 301, networks 303, 305, 307, and 309 (FIG. 1c), network 401 (FIG. 1b).

The TCP/IP application fund-raising request is converted to packets. The packets contain ID tags, and the network addresses of remote respective contributors' computers 107 (FIG. 1c), remote prospective contributors' computers 800-806 (FIGS. 1b and FIG. 3) and the other remote prospective contributors' computers receiving the fund-raising request(s). In a variant, networks 301, 303, 305, 307, 309 (FIG. 1c) and 401 (FIG. 1b) are packet switched networks. As such, fund-raising request packets travel independently using multiple paths to destinations. The destinations of the fund-raising requests are identified by a unique name and/or a numerical address by the fund-raiser on computer 103 (FIGS. 1c and 3) or computer 405 (FIG. 1b), or other computer.

A fund-raising computer 103, 405 is used by a fund-raiser to transmit or communicate a fund-raising email request for the solicitation of a multiplicity of contributions from the prospective contributor email recipients on networks 301, 303, 305, 307, 309, and 401. Fund-raising computer 103, 405 uses email addresses for the recipients of prospective cardholder contributors in a variant.

For example, a computer network email recipient email address contains the necessary information needed to deliver the email fund-raising request to a prospective cardholder contributor's computer, e.g. remote prospective contributor's computers 107, 800-806 (FIGS. 1b and 3) on the networks. The email address comprises a local portion and a host portion. The prospective contributor username refers to the mailbox, login name, or user id of the recipient cardholder contributor. The local portion and the host portion of a recipient prospective contributor are separated by an “@” symbol: prospective cardholder contributor username @ hostname.

A fund-raiser's computer 103, 405 sends a fund-raising request or solicitation message to a prospective contributor's computer 107 or a multiplicity of prospective contributors' computers on networks 301 303, 305, 307, 309 and/or 401. It will be understood that a fund-raising email request is usually sent to its destination at a prospective contributor's computer or prospective contributors' computers in a matter of seconds, with the resulting benefit that contributions, including contributor cardholder card, e.g. credit card or debit card information and numerical contribution amount information, optionally encrypted cardholder account information, cyber-cash account information, cybercash, or ecash (electronic cash) (referred to herein as “contribution information”), are also returned to fund-raiser's computer 107, 405, a plurality of fund-raiser's computers, a card account processor computer 1031 (FIG. 3), a bank computer, or the like within a matter of seconds. Hence, contributions made are available for use by a fund-raiser within a minimum amount of time. This benefit is most appreciated where time is of the essence as in the case of relief efforts in natural disasters and the like.

For example, assume that a natural disaster strikes Japan. A fund-raiser generates a message depicting audio, visual, or a combination thereof, presentations of the natural disaster and a message or request 5005 (FIG. 1a) for inducing prospective contributors at remote computers 800-806 (FIGS. 1b and 3) and remote computer 107 (FIG. 107) to make contributions to assist in disaster relief. The message or request for a contribution 5005 is communicated 5007 to a plurality of remote computers 800-806, 107 along respective communication links and computer networks so that message or request 5005 reaches the respective destinations. Message or request 5005 is displayed on respective remote computer displays on computers 800-806 and computer 107. It will be appreciated that requests for contributions from tens of millions of prospective contributors are communicated during the occurrence of the disaster or shortly thereafter. Moreover, requests for contributions are communicated to all nodes on computer networks which are located on all seven continents worldwide in a variant. By way of example, remote prospective contributor's computer 800 is located in Germany, remote prospective contributor's computer 805 is located in the United States of America, remote prospective contributors computer 803 is located in Argentina, remote prospective contributor's computer 801 is located in South Africa, remote prospective contributor's computer 804 is located in Australia, remote prospective contributors computer 107 is located in China, etc.

Optionally, contributors are cardholders, e.g. contributors who are issued or who control credit cards, debit cards or combinations thereof. In a variant cardholder information, cardholder account information, numerical contribution amount information, indicia from information bearing cards, or combination thereof (referred to herein as contribution information) from each respective contributor is entered onto respective contributors' computers 800-806, 107. The contribution information is communicated along respective communication links 140 (FIG. 3), 450-456, to respective computer networks 301, 303, 305, 307, 309 to a card processor 1031, bank, fund-raiser's computer 107, 405, other remote computer or combination thereof. In a variant, the contribution information is encrypted 5008 (FIG. 1a) on the respective contributors' computers 800-806, 103, on cursor controlling devices 100 (devices having a card reader 307), other card reading peripheral (not pictured), at a remote computer on the networks, or combination thereof. The encrypted contribution information is communicated from the respective remote contributors computers 107, 800-806 to a card account processor 1031 (by way of example) for decoding 5010 and further processing. Exemplary encryption technologies include those of RSA Corporation and others known in the art. Further processing includes debiting respective contributor accounts and crediting respective fund-raiser accounts 5012, 5014 (FIG. 1a).

In a variant, contribution information includes contributions that have account information and numerical amounts, and data sets comprised of indicia representative of monetary units. That is, contributors on respective contributors' computers 107, 800-806 communicate contribution information packets representative of monetary units, currency, or other consideration. These information packets are contribution information in this variant. They may include the electronic equivalent of currency (electronic cash, ecash, cybercash), account information correlated to numerical contribution amounts, and the like. This type of contribution information is also optionally encrypted.

The contribution information is communicated from the remote prospective contributors computers during a contribution session. It will be appreciated that contribution sessions using the present invention are no longer limited to physical restraints such as the size of auditoriums, sports facilities and the like. Rather national, global, and even extraterrestrial contribution sessions are held using the present invention. Analogously, it is understood that the number of contributions that are requested, and made using the present invention is in the tens of millions of contributions in a variant.

A fund-raising request, message or email solicitation comprises text in one variant. In another variant the fund-raising request or email solicitation comprises a multimedia presentation. A multimedia presentation includes video and/or audio portions thereof. The fund-raising request preferably provides a stimulus inducing the making of a monetary contribution. The fund-raising request also is sent as a courtesy copy to prospective contributor's computers.

The fund-raising request comprises a header portion and a body portion in a variant. These two portions are separated by a series of blank spaces. The request is stored in the prospective contributor recipient's in boxes.

The prospective contributors reply to the fund-raising request or solicitation on their remote respective computers 107, 800-806 or on computers they are then utilizing. The contributor(s) reply utilizing information from the request subject field. This information is used to address the response. In a variant the original fund-raising request message is included within the reply message.

Prospective contributors' email addresses are obtainable from commercially available “white pages” listing email addresses. Moreover, the present invention contemplates utilizing commercially available “on-line” directory assistance to obtain email addresses of prospective email contributors, e.g. on-line “white pages.”

Fund-raiser's computer 103, 405 sends a fund-raising request or solicitation to prospective contributors, e.g. cardholder contributors, on a plurality of networks 301, 303, 305, 307, 309, 401 and receives responsive cardholder contributor card information and, optionally, numerical contribution amount information therefrom. In a variant, a designation of a predetermined numerical contribution amount is communicated in the fund-raising request or solicitation to the remote prospective contributors' computers and correlated to the respective contributors' contribution information. The requests or solicitations and responsive contribution information (card information, contributor account information, electronic currency, numeric contribution amount information, or combination thereof) are communicated between the networks 310, 303, 305, 307, 309, 401, or combination thereof, to reach a destination. Networks 303, 305, 307, and 309 are communicatively connected to network 301 by way of email gateways 310, 311, 313, and 315 respectively. and network 401 is also connected by an email gateway to network 301 (not shown). Email gateways include computers communicatively connected to two or more networks and capable of translating different email languages. By way of example, a fund-raiser on America On-line can send a fund-raising email request or solicitation to a multiplicity of contributors, e.g. cardholder contributors, computers on Compu-serve, and the contributors on this network can reply by forwarding contribution information to the fund-raiser's computer 107, 405, card account processor computer 1031, VISANet, a card processing network, or combination thereof.

By way of example, a prospective contributor's email address includes a specification of the gateway-hostname. It will be understood that an extremely large number of prospective contributors', e.g. cardholder contributors, computers are forwarded requests or solicitations within a short amount of time. Moreover, it is further understood that the time in which contributions are received is greatly accelerated. Further it is understood that the number of prospective cardholder contributors who are contacted is greatly increased over known methods of fund-raising including broadcast television and the like.

A fund-raiser utilizes fund-raising email lists, e.g. electronic mailing lists, in a variant. A fund-raiser's electronic mailing list comprises tens of hundreds of prospective contributors addresses. Moreover, the fund-raiser assembles a list that is focused on environmental, social, religious, or charitable issues. Prospective contributors subscribe to a fund-raiser's list in a variant. Once subscribed a prospective contributor's computer receives solicitations or requests from the fund-raiser.

For example, the Republican or Democratic committees assemble an electronic mailing list of party members or prospective contributors locally, or nationwide. Electronic mail solicitations are forwarded to the respective party members to make contributions to a candidate, the party, a cause, or combination thereof. Responsive to the request the party members or prospective contributors communicate contribution information from their respective computers 107, 800-806 to card account processor computer 1031, the respective parties' computers 103, 405, or another remote computer for processing. It will be understood that the present invention allows for nationwide fund-raising. That is a nationwide convention can be held. For example, respective contributors' remote computers 107, 800-806 have the addition of video hardware and software in a variant and are linked to party headquarters or a rally for a candidate and the like.

A fund-raiser can include a charitable organization. A charitable organization generally is an organization that is awarded nonprofit status by the IRS, or other tax processing governmental body. Charitable organizations include nonprofit tax exempt organizations that are classified under Section 501(c)(3) of the IRS Code. This classification is a reliable indicator of the tax deductibility of contributions. Charitable organizations defined under Section 501(c)(3) of the IRS Code are divided into two classes: public charities and private foundations. A public charity solicits funds from the public and uses the funds to sponsor or support social, educational, or religious activities, or engage in activities that provide for relief for distressed or underprivileged individuals. Public charities are defined in Section 509(a)(1-4) of the IRS Code.

Included in the group of charitable organizations are churches, conventions or associations of churches; educational organizations; hospitals and medical research organizations; organizations created to benefit state and municipal colleges and universities that normally receive their support from the government or the general public; and other publicly supported organizations such as museums, libraries, support groups for cultural organizations, organizations for the gathering of contributions for research into and the elimination of medical disorders, and organizations that provide direct services to the public.

Fund-raising organizations also include organizations that receive the majority of their support from activities relating to their tax exempt functions, such as a museum's receipts or tuition paid to an educational institute. Fund raising organizations also include public television, radio, and other forms of media organizations that derive support from the public by way of contributions.

Fund-raising organizations also include those organized exclusively to support other qualified public charities, such as churches, schools, and hospitals; those operated for the purpose of testing products for public safety; and, private foundations established to maintain or aid social, educational, religious, or other charitable purposes.

A “fund-raiser” or “fund-raising organization” is a private foundation; a tax exempt corporation; a not-for-profit corporation; an organization organized and operated exclusively for religious, charitable, scientific, testing for public safety, literary, or educational purposes, to foster national or international amateur sports competition, and/or for the prevention of cruelty to children or animals; a civic league; an organization not organized for profit but operated exclusively for the promotion of social welfare; and, private for profit an not-for-profit organizations that gather a contribution on behalf the above mentioned organizations. Exemplary organizations may include the Red Cross, the Boy Scouts, the Girl Scouts, Salvation Army, American Heart Association, American Diabetes Association, United Way Crusade of Mercy, high schools, grammar schools, colleges, museums, and fund-raising arms of other organizations, the like.

A “fund-raising organization” and/or “fund-raiser” also includes a political organization, a party, committee, association, fund, or other organization, fund, or other organization (whether incorporated or not) organized and operated primarily for the purpose of directly or indirectly accepting a monetary contribution or making an expenditure, or both, for an “exempt function.” An exempt function includes the function of influencing or attempting to influence the selection, nomination, election, or appointment of an individual to any Federal, State, or local public office or office in a political organization, or the election of Presidential or Vice-Presidential electors, whether or not such an individual or electors are selected, nominated, elected, or appointed; and, a campaign committee, and/or a fund established for the nomination or election of an individual to a Federal, State, or Public office.

A “fund-raiser” or “fund raising organization” can also include an adhoc committee or organization created for the direct or indirect gathering of a monetary contribution for a charitable goal. It may include an organization or fund established for a humanitarian purpose such as raising resources for an organ transplant, for feeding or clothing needy people, and the like. Of course the term fund-raising organization and fund-raiser also includes individuals or organizations acting on behalf of the organizations referenced above.

Information bearing cards as referred to herein are used for making of a monetary contribution by a contributor who is a cardholder. An example of an information bearing card is a credit card including, credit cards issued by an organization. Such cards are: VISA, Mastercard, Discover, and an American Express cards. An information bearing card as used herein refers also to a debit card including, by way of example, a Cirrus card, a Plus card, a Maestro card, an Interlink card, and any other type of card that can be used for an electronic fund transfer. The term “card” also contemplates a private label card issued or maintained by a fund-raising organization or an affiliate of a fund-raising organization, and a prepaid card that can be purchased by cash, check, credit, or debit cards. An information bearing card can be a credit card, debit card, or combination thereof.

Optionally, the request for authorization or verification, authorization step, verification step, or combination thereof, is decoupled from each respective contribution at the time the contribution of a respective contributor's respective card information and contribution amount information is made into a contributor's respective computer 107, 800-806.

It will be further understood that tens of thousands, and tens of millions of contributions can be accepted in a short amount of time, e.g. during a single contribution session, utilizing this method and that contributions that are later found to be unauthorized can be discarded and only authorized contributions are then credited to a fund raiser's account and debited to a contributor's account. Moreover, the time that a contribution session generally takes is greatly reduced using the present invention. Contributions are made by tens of thousands, and even tens of millions of contributors simultaneously on their respective computers 107, 800-806.

It is also possible to store the group of unauthorized contributions so that the contributors making these contribution can be contacted to resubmit their respective contributions. An email receipt is used to substantiate a contribution. Substantiation may be required to receive a tax benefit from a governmental taxing authority, e.g. the Internal Revenue Service, or a state or local taxing or tax processing body. A receipt for a contribution appears on a contributor's monthly credit card statement, bank statement, or combination thereof. Optionally, an annual, or after some other appropriate time period, a statement is forwarded to a respective contributor itemizing all contributions given, e.g. to charitable organizations, for tax purposes, or otherwise. The format of the statement can be such that a tax processing entity, e.g the IRS, will accept the information for substantiating the contribution or group of contributions at issue, and/or grant a charitable contribution deduction. It will be understood that records of the contributions made by tens of hundreds of cardholder contributors can be easily be processed and forwarded to each respective contributor of the tens of hundreds contributors for meeting contribution quotas and for substantiating charitable contribution deductions and the like given at a plurality of prospective contributors' computers.

In an embodiment, a plurality of contribution data are transmitted by way of network 301, 303, 305, 307, 309, 401 or a combination thereof, to a fund-raiser's computer 107, 405 or another computer of a party acting on behalf of the fund-raiser. The contribution data comprises card information from an information bearing card and associated numerical contribution amount information from a plurality of contributors are grouped together. The grouped information is then transmitted to a card account processor. The card account processor authorizes a sub-group of contribution data for further processing. The authorized and unauthorized contribution data can be transmitted to a fund-raiser's computer 107 for exclusion of the unauthorized contribution data. The unauthorized contribution data can be excluded if desired at a card account processor. The unauthorized contribution data are excluded from the group, and the authorized contribution data, e.g. card information and contribution amount information, are transmitted to the card account processor. Means responsive to information sent via a transferring means enters a debit representative of the contribution amount information to an account of the contributor. Means responsive to information sent via the transferring means enters a credit representative of the contribution amount information to an account of a fund-raising organization. The contribution data is further processed and a record of the contribution for substantiating a contribution is forwarded to a card account processor.

A prospective contributor's email contribution request or solicitation has a display option or icon that represents a specific denomination amount, e.g. five dollars ($5) or ten dollars ($10). The specific denomination amount appearing on a respective contributor's screen is of an order to induce the making of a contribution in a variant.

In another variant, a cardholder contributor enters his card information or passes his information bearing card through a card reader 307 on mouse 100 (FIG. 1b), trackball or other computer peripheral communicatively linked with computers 107, 800-806. Information regarding the type of card read is detected, e.g. a determination is made whether a premium card has been read such as a “GOLD CARD” versus some other type of card (“A CLASSIC CARD or VISA BUSINESS”), or whether other indicia regarding a contributor's credit worthiness, credit limits, or affluence are present. It will be appreciated that cardholders with high credit limits or bearing a premium card such as a gold card can be more affluent individuals tending to contribute larger contribution amounts. If a premium card is detected or if other information indicative of the cardholder's credit worthiness or affluence is detected, recommended contribution amounts appear on display of computer 107, 800-806. These recommended contribution amounts can be larger recommended contribution amounts. By way of example, when contributor_{A} passes his information bearing credit card that is a VISA® GOLD Card through card reader 307. The information indicative of the type of card that contributor_{A}'s card is, is processed via software routines and a single or a plurality of recommended contribution amount keys appear on terminal 100's touch screen interface, e.g. $100, $150, $500. In a variant, when contributor_{B} passes his information bearing credit card that is a VISA® CLASSIC Card through card reader 307. The information indicative of the type of card that contributor_{B}'s card is processed via software routines and a single or a plurality of recommended contribution amount keys appear on terminal 100's touch screen interface, e.g. $10, $15, $20. It will be seen that the cumulative amount of a group of respective contributions that are received from a group of cardholder contributors in a single fund-raising session will be maximized utilizing this apparatus and method.

In a variant, the email location of a remote prospective contributor is correlated with data reflecting the relative affluence of the prospective contributor or other data reflecting the inclination of a contributor to give to a particular cause or organization. This data includes the physical location of a respective contributor's computer, e g. the geographic location, historical giving information correlated to a respective contributor, and the like. Based on this correlation fund-raiser's computer 103, 405 communicates a higher or lower recommended contribution amount to a respective contributor.

By way of example, assume there are remote prospective contributors' computers 800-802 at email locations A, B, and C respectively. Computer 800 at email location A is in geographic location in an affluent suburban area, computer 801 at email location B is correlated with a prospective contributor who has historically contributed large contributions, and computer 802 is at email location C who has historically contributed to charities but in smaller amounts than the contributor at email location B. In order to maximize the contributions over the three exemplary email locations: Computer 800 is sent recommended contribution amount requests of $100, $200, $500, and $1000; computer 801 is communicated recommended contribution amount requests of $500, $1000, $5000, and $10,000; and computer 802 is transmitted exemplary contribution request of $5, $10, $50, and $100. It will be understood that this selective transmission of recommended contribution amounts will increase the total contributions gathered from the respective contributors. It is further understood that the correlation of the giving potential of each respective contributor and respective email address can be made, by way of example, at fund-raiser's computer 103, 405, computers 107, 800-806 or other remote computer.

Most credit card contribution amounts will not require an authorization by signature or numeric code. Consequently, the present invention contemplates that a contributor will simply need to enter information bearing card information onto the computers 107, 800-806, or on peripherals 100 as required, and enter the amount of his contribution by pressing a key associated with a cash denomination in making his contribution on a key pad of the computers or on peripheral 100 by positioning a cursor as needed on a display portion of the computers, and “clicking” an appropriate button. In a variant, a prospective contributor has bank account information, information or data packets representative of electronic currency, or card information stored on his or her respective computer 107, 800-806 in data storage analogous to data storage 302. In one variant, contribution information comprises bank account information correlated with numerical contribution amount information, data packets representative of electronic currency, card information (optionally encrypted) correlated with a numerical contribution amount, or combination thereof, and is communicated from data storage analogous to data storage 302. That is a plurality of data sets comprised of contributions are communicated over computer networks from respective contributors' remote computers for storage in a data storage on a remote computers. Where there are a plurality of causes, fund-raising organizations, etc. data sets comprised of contributions made to respective causes or fund-raising organizations are grouped together in a data storage and segregated from other respective data sets. These grouped data sets are then communicated as a group to a bank, card account processor, etc. for further processing. It will be appreciated that prospective contributors' computers include communication circuitry analogous to communication circuitry 990 (FIG. 3).

The respective contribution information, e.g. card information and numerical amount information, is transmitted by way of the computer networks 301, 303, 305, 307, 309, 401 or combinations thereof as appropriate to another computer, e.g. computer 107, 405, 1031 for post-processing. The contribution information, e.g. card information and contribution information, electronic currency information, information used to debit an account for the numerical amount of the contribution, or combination thereof, is then post processed. Post processing includes transmitting the contribution information, e.g. card information and contribution information or contribution information for a group of contributors, to a card account processor or bank to request a verification or authorization for crediting and debiting of the appropriate accounts, or combination thereof.

The present invention contemplates that a contributor will have pre-authorized the fund-raising organization to collect a contribution amount. Pre-authorization can include an agreement with the organization that a contributor authorizes the contribution of a given amount once a certain action takes place, e.g. the contributor enters credit card or debit card information or credit card account number or a debit card account information, onto his respective computer as mentioned above. The pre-authorized contribution amount and the contributor's card information are correlated, and forwarded to a card account processor for post-processing.

By way of further example, a contributor enters into an arrangement with a fund-raising organization. The arrangement is that the fund-raising organization will associate a preferred contribution amount with the contributor's card information, electronic currency information, account information, or combination thereof, each time the contributor enters his respective card information into his computer 107, 800-806 or each time an icon is selected. It will be appreciated that this method allows for the contributor to simply enter his card information or account on the computer once to make a contribution. Less time is spent by the contributor focusing on the financial aspects of the transaction.

In the case of a debit card contribution or other debit type of contribution via computer 107, 800-806, the contributor can authorize the fund-raising organization to use a secret identification number associated with his debit account in order to allow the organization to automatically obtain the contribution without seeking subsequent authorization from the contributor. Alternatively, the contributor may enter his personal identification number (PIN) onto computer 107, 800-806, or combination thereof, and the computer 107, 800-806 stores the PIN in an encrypted form for later processing. As discussed in my other disclosure, peripheral 100 (FIG. 1b) has encryption hard-ware and/or software for accomplishing same. In this scenario, the contributor need only perform the action of swiping or inserting, as required, information bearing card through or into a card reader to make a contribution. The secret identification number is associated or correlated with the card information, account information, contribution amount information, or combination thereof, and forwarded to a card account processor for post processing. In this variant, post processing includes obtaining appropriate authorizations, and crediting and debiting the contributor's account and the fund-raising organizations account, or combination thereof, as required.

A single or a plurality of contributions are stored in data storage 302 on fund-raiser's computer 103, 405. A set of software routines associates or correlates a contributor's card account information or a respective contributor's information representative of electronic currency with a numerical contribution amount. The contributor has made a number of contributions within a specified time period which are stored and tallied by a set of software routines.

Further optional visual prompts appear on the prospective contributors' terminals that include a prompt appearing on a display requesting additional identification information of a contributor, e.g. the address of an contributor, a prompt requesting a special intention, or combination thereof. Further an optional message prompt may include the following text portions: “SLIDE CARD THROUGH CARD READER 307,” “ENTER Contribution AMOUNT,” “PRESS YES,” “ENTER OFFERING AMOUNT,” “ENTER CONTRIBUTION,” a variation on the themes of the text, or combination thereof. In a variant, a fund-raising request 5000 is communicated to computers 107, 800-806 and results in the respective remote contributors' computers to audible prompt the contributors to make contributions.

As previously discussed a multi-media presentation “email” solicitation is sent to prospective contributors' computers on the various networks 301, 303, 305, 307, 309, 401, or combination thereof. The multi-media presentation includes audio and video portions that induce a contributor to make a contribution. Both the fund-raiser's computer 103, 405 and the prospective contributors' computers 107, 800-806 have hardware and associated software to provide a video link (not shown).

An email request for contributions or fund-raising message also includes display messages and audio messages for simplifying and inducing the giving of contributions by contributors to a plurality of fund-raising organizations or causes, e.g. Save the Apes, Save the Kangaroos Fund, and Save the Lions Fund. Contributions for all of these causes can be made during a single contribution session or on a single email request for contributions. Optionally, an e-mail message is used to induce, solicit, facilitate, and receive contributions for a plurality of causes within a specific fund-raising organization. The email message is used in the method of simplifying and inducing the giving of contributions, receiving and immediately recording thereof upon receipt.

The method comprises the steps disclosed herein comprising providing or communicating to contributors making monetary contributions with an email message and a means for entering and transmitting contribution information to an account of a fund-raiser or a fund-raiser's computer. In a variant of the method, contribution information is card information and correlated numerical contribution amount information. The email message information packet soliciting the making of a contribution has means for associating or correlating a numerical contribution amount with account information, correlating corresponding contribution information with information representative of a particular cause, fund-raising organization, account within a fund raising organization, or combination thereof. There is also an association or correlation with a respective contributor's information bearing card information, respective contributor's numerical contribution information, and a particular cause, fund-raising organization, account within a fund raising organization, information representative of electronic currency information, or combination thereof.

By way of further example, the email message information packet soliciting the making of a contribution has a functionality for associating indicia representative of a particular cause, fund-raising organization, account within a fund raising organization, or combination thereof. The reply portion to the email message information packet designates a contribution to a “Save the Apes” fund or account, designates a contribution to a “Save the Kangaroos” fund or account, designates a contribution to a “Save the Lions” fund or account. A contributor designates which fund he wishes his contribution to go to, e.g. by designating the “Save the Kangaroos” fund or account; by designating a contribution to a “Save the Lions” fund or account; or, by designating a contribution to a “Save the Apes” fund or account. In a variant, the contributor's card information and designated contribution monetary amount is associated with his cause designation and transmitted onto the computer network(s) 301, 303, 305, 307, 309, 401, or combination thereof to its destination, e.g. a fund-raisers' computer 107, 405, a clearinghouse computer, a card processor's computer 1031, a bank computer, or a combination thereof.

Fund-raiser's computer 107, 405 stores the associated and designated information for eventual off-loading thereof in a variant. Off-loading is to a card account processor 1031, a funds processing network, or combination thereof. The contributor's contribution information, e.g. associated card information and contribution amount, and designation is then routed to a particular account. An account can be a separate account within a fund-raising organization group of accounts, an account of a particular fund-raising organization within a group of fund-raising organization accounts, or combination thereof. In a variant, all of the designated contribution monetary amounts are funnelled to a single account. A particular account also has an electronic mail address of its own in a variant.

Provision can be made for a prompt or an icon on a prospective contributor's computer display which prompts a contributor to enter his contribution information. For example, a contributor enters his contribution information by entering information representative of electronic currency or an account to be debited on a keyboard, by selecting an icon on a display, or combination thereof. Another prompt on the prospective contributor's display prompts the contributor to select a particular cause to which he wishes make a contribution. For example, the contributor selects the “Save the Apes fund or account.” The contributor selects the appropriate icon on his computer screen portion with his mouse or trackball. The contributor is prompted to enter a numerical contribution amount. For example, the contributor selects $50. The contributor's selection of a numerical contribution amount, e.g. $50, and selection of, e.g. “The Save the Apes Fund,” are associated or correlated with the contributor's card information from his respective information bearing card in a variant, and stored in the contributor's computer 107, 800-806 temporarily for communication to remote fund-raiser's computer 107, 405, or is sent in real time to the fund-raiser's computer 107, 405 or a card account processor 1031. A plurality or multiplicity of contributors make their subsequent selections and contributions on their respective computers. The associated contribution information, e.g. card information from each respective contributor, contribution information from each respective contributor, and designation of cause, fund, or account, are then stored in data storage 302 on the fund-raiser's computer 107, 405 for eventual off-loading therefrom to a card account processor 1031, a fund-processing data base, a bank, or combination thereof, for further processing. Where the fund-raiser's computer stores segregated data packets comprised of contributions, the segregated data packets comprised of contributions correlated to respective causes are sequentially communicated to a card account processor, bank, etc. It will be appreciated further post contribution processing can include preparation of a record substantiating the contribution that is then forwarded to the contributor for tax purposes and the like.

The data sets requesting the making of monetary contributions and fund-raising monetary contribution requests are associated with organizations such as the American Red Cross, American Cancer Society, American Diabetes Society, or other fund-raising organization. As will be appreciated contributions can be gathered at funeral homes, hospitals, charitable balls, concerts, and the like, for these various causes. Likewise, contributors' computers 107, 800-806 are located at hospitals, funeral homes, concerts, charity balls, and the like in a variant for use by attendees. It is also appreciated that the stimulus for making a contribution and for making a contribution of a greater numerical amount are greatest where computers 107, 800-806 or the present invention are located at these types of locations. The locations of terminals 107, 800-806 at these locations promotes increased giving.

In the example of political fund-raising as contained herein, an email message includes indicia representative of a particular candidate for political office, e.g. Ronald Reagan or Dan Quayle, a particular political office, e.g. President, Mayor, Senator, Representative, Judge, political party committeeman, or combination thereof, presented to a multiplicity of prospective contributors. By way of example, a contributor designates which candidate, party, and/or political office he wishes his contribution to go to on his respective computer. The contributor's contribution information is associated with his designation.

Provision can be made for a prompt on a display of computer 107, 800-806 which prompts a contributor to enter his contribution information. By way of example, the contributor selects a candidate for President. A mouse or a trackball is also used to position a cursor over and icon and to designate, e.g. a Senator or Senate seat, and a Mayor on the prospective contributor's computer. Designations or icons appearing on the prospective contributors' computer displays include indicia representative of national, state, and local political offices or candidates. The contributor is prompted to enter a recommended numerical contribution amount, or confirm a pre-designated contribution amount. Assume the contributor selects $50. The contributor's selection of a numerical contribution amount, e.g. $50, and selection of, e.g. President, are associated with the contributor's contribution information and transmitted in real time to fund-raisers' computer 107, 405, a card account processor 1031, a bank computer, or combination thereof.

In a variant, the contribution information, e.g. card information, contribution information and designation of candidate or political office, for a multiplicity of contributors are transmitted via the computer networks 301, 303, 305, 307, 309, 401 or combination thereof, to a single or a plurality of remote computers, and stored in a data storage for eventual off-loading thereof. Off-loading can be to a card account processor 1031, a fund-processing data base, a bank, or combination thereof, for further processing.

Prospective contributors' computers 107, 800-806 simplify the giving of contributions by contributors to causes within a religious organization, e.g. First collection, Second Collection, and Cardinal's Appeal, in a variant. An email message or packet of data requesting the making of a contribution, e.g. a multimedia message containing, a video portion, an audio portion, or combination thereof, is used in the method of simplifying and inducing the giving of contributions, receiving and immediately recording thereof upon receipt. Provision can be made wherein a religious organization designates to which collection, or cause, a sub-group of contributions within a larger group of contributions made during a session is correlated, or associated therewith. Means are provided for the designation or grouping of a sub-group of contribution transactions for a particular collection of cause. There is a means for designating a particular collection, e.g. by icon selection by mouse or trackball.

A portion of a prospective contributor's computer screen represents a designation of a contribution to the “First Collection” fund or account, represents a designation of a contribution to a “Second Collection” fund or account, and/or represents a designation of a contribution to a “Cardinal's Appeal” fund or account. A contributor designates which fund he wishes his contribution to go to, e.g. by positioning a cursor over the respective portion of a screen or by pressing a key on this computer keyboard. The contributor's card information and contribution amount is associated with his designation. The respective contributor's computer 107, 800-806 temporarily stores the associated and designated information in data storage for eventual off-loading thereof or transmits same via the respective communication links as described in real time. Optional encryption is provided for the contributor's contribution information, card information, bank account information, PIN numbers, or combination thereof. Off-loading is to a card account processor, a funds processing network, or combination thereof. The contributors' associated contribution information and designation is then routed to a particular account. Such an account can be a separate account within a religious organization, an account of a cause within a group of religious organization accounts, or combination thereof at a respective electronic mail address.

For example, tens of thousands of contributions (“L” contributions) can be made simultaneously in one variant, or sequentially in another variant, in the manner described herein on a plurality or multiplicity of computers 107, 800-806 on the networks 301, 303, 305, 307, 309, 401, or combination thereof. A plurality of prospective contributor's computers, e.g. computer₁ . . . through computer_{Z} are on the networks. Tens of hundreds or of thousands of contributions, have been received, stored, or a combination thereof, by a fund-raiser's computer 107, 405 before interposing a request for verification or authorization, authorization step, verification step, or a combination thereof, between two respective contributions within the group of contributions. It is understood that this greatly decreases the time needed to process this huge number of sequentially made or simultaneously made contributions.

In the scenario where contributor 1 has contributed contributor 1's respective contribution amount of $5.00, and his respective card information, or correlated account information; where contributor 2 has contributed his respective contribution amount of $10.00 and his respective card information or account information; and, where contributor 3 has contributed his respective contribution amount of $50.00 and his respective card or correlated account information, contributor N has contributed his respective contribution amount of $100.00 and his respective card information or correlated account information, data storage in a remote computer, e.g. a fund-raiser's computer 107, 405 or a bank computer, receives and stores the following:

| | |
|---|---|
| Contributor 1's card information | $5.00 |
| Contributor 2's card information | $10.00 |
| Contributor 3's card information | $50.00 |
| Contributor N's card information | $100.00 |

It is appreciated that card information includes account information from which a contribution is debited or charged. Subsequently, in a variant the remote computer transmits:

Contributor 1's card information and associated $5.00

Contributor 2's card information and associated $10.00

Contributor 3's card information and associated $50.00

Contributor N's card information and associated $100.00

to a fund-processing network.

Optionally, an authorization is obtained at card account processor for each contribution transaction. By way of example, information designating each contribution as authorized or unauthorized may be added to each respective contribution:

Contributor 1's card information and associated $5.00—unauthorized

Contributor 2's card information and associated $10.00—authorized

Contributor 3's card information and associated $50.00—authorized

Contributor N's card information and associated $100.00—authorized

The authorized contribution transactions are then processed further. Processing includes debiting or charging, as appropriate, an account of a contributor for the amount of the authorized contribution. By way of example,

Contributor 2's account is debited $10.00;

Contributor 3's account has a charge added to it of $50.00; and,

Contributor N's account has a debit entered to it of $100.00.

An account of a fund-raising organization is augmented the amount of the authorized contributions. By way of example, fund raiser's account would be augmented for the $10.00 received from contributor 2, for the $50.00 received from contributor 3, and for the $100.00 received from contributor N.

Contributor 1's contribution was unauthorized. As an unauthorized contribution it may be reported to the fund raising organization. The fund raising organization may choose to follow up with Contributor 1 to determine if the contributor would like to make a subsequent contribution. Optionally, contributor 1's card information and respective contribution amount of $5.00 may be discarded.

Optionally, as each contributor, e.g. 1, 2, . . . N, enters his respective contribution amount on his or her respective computer 107, 800-806, the computer 107, 800-806 communicates the respective contribution amount for each contributor to a remote computer by a computer network.

In a variant, assume, contributor₁ makes contribution transactions 1 through 100 during a specified time period, e.g. one week, one month, one year, one taxable time period. Contribution transactions 1 through 100 are grouped into authorized and unauthorized transactions. Assume contribution transactions 95 through 100 are unauthorized, and contribution transactions 1 through 94 are authorized. Contribution transactions 1 through 94 are grouped into contribution transactions that qualify for a charitable contribution deduction and those that do not qualify for a charitable contribution deduction. Assume that contribution transactions 1 through 50 qualify for a charitable contribution deduction and that contribution transactions 51 through 94 do not quality for a charitable contribution deduction. Contribution transactions 1 through 50 are then be forwarded to a contributor, e.g. by mailing a record of the contribution transactions or electronically forwarding signals representative of the contribution transactions to a contributor, tax processing body, e.g. the IRS, a fund-raising organization, e.g. a church, or a combination thereof. It will be understood that signals representative of contribution transactions 1 to 100, signals representative of an accounting report, or a combination thereof, are sent to a fund-raising organization from a card account processor 1031, settling bank, issuing bank, merchant bank, or a combination thereof, via a communication link 140. The process is repeated for contributor₁ through contributor_{N}. It will be understood that a large number of contribution transactions can be substantiated and accorded the status of a charitable contribution deduction, and a substantial amount of transaction costs saved which would have to expended for substantiating charitable contributions made by contributors, including cardholder contributors, to fund-raising organizations by employing the computers on the network(s) and methods referred to herein.

A record of a contribution or a group of contributions is routed to a mailing service, e.g. the U.S. Post Office, a private mail courier, or the like. The mailing service delivers the record of the contribution transaction to a mailing address of contributor. The record of the contribution is used by the contributor to substantiate the contribution made to the fund-raising organization. Substantiation may be made to a national, state, or local taxing body, e.g. the Internal Revenue Service. It will be understood that the transaction costs associated with providing substantiation for charitable contribution deductions, and the like, for a plurality of cardholders who are contributors will be reduced by utilization of the above method.

In an alternate method, the method comprises the step of forwarding a record of the contribution transaction to contributor N by electronically mailing, e.g. e-mailing, a record of the contribution transaction to contributor N using a communication link, e.g. phone lines. In a variant, a portion of the email request for a contribution represents a data packet containing contribution substantiation indicia. Where a contribution is made, the data packet containing contribution substantiation indicia is activated to remain on the contributors' computer in a data storage. At a later time a hard copy of the contribution is printed.

By way of further example, a periodic statement regarding contributions is sent to a contributor via a network of computers 301, 303, 305, 307, 309, 401, e.g. Prodigy, America On line, and the like, to a contributor's home computer via a communication link, e.g. a telephone hook up.

The record of the contribution transaction is forwarded by a bank, a card account processor, by way of example, Card establishment Services of Melville, N.Y., or VISA Merchant Bank Services of San Mateo Calif., a fund-raising organization, an issuing bank, a processing bank, a merchant bank, or combination thereof to contributor N.

In yet another embodiment of the method, a record of the contribution, or a plurality of contributions made by a contributor, are electronically forwarded, mailed, or combination thereof, to a governmental tax processing body, e.g. the Internal Revenue Service, also on the computer network(s). It is appreciated that the method disclosed herein has a number of benefits, including the reduction of the work and resources associated with preparing tax returns and claiming charitable contribution deductions, reducing the amount of fraud associated with claiming charitable contribution deductions, reducing the amount of work a governmental tax processing authority has to do when processing charitable contribution deductions.

The method provided above can also include the step of associating with charitable contribution data a tax identification number of a contributor, e.g. a social security number of a contributor and the like, a tax return for a contributor, or a combination thereof. It will be appreciated that the association of the tax identification number associated with a contributor, a tax return of a contributor, and a contribution transaction or plurality of contribution transactions for a contributor, and the direct forwarding of the contribution transaction information to a tax processing governmental body will greatly simplify the processing of charitable contribution deductions and the like and decrease fraud associated therewith.

The present invention further contemplates forwarding a record of contributions to a fund-raising organization, a contributor, or to a contributor on behalf of a fund-raising organization from a card account processor 1031, a bank, or combination thereof. As will be appreciated utilization of this method provides the benefits of decreased paper work for fund-raising organizations involved with substantiating contributions made by contributors.

The method further optionally includes the step of providing a contemporaneous, or subsequent, written acknowledgment or record of the contribution by the fund-raising organization. The acknowledgement or record substantiating a contribution includes the following information, or combination thereof:

(1) The amount of cash or equivalent card information and numerical contribution amount contributed;

(2) Whether the fund-raising organization provided any goods or services in consideration, in whole or in part, in exchange for the cash contributed; and,

(3) A description and good faith estimate of the value of any goods or services referred to in (2) above of, if such goods or services consist solely of intangible religious benefits a statement to that effect.

The term intangible religious benefit refers to any intangible religious benefit which is provided by an organization organized exclusively for religious purposes and which generally is not sold in a commercial transaction outside the donative context. An acknowledgement is considered contemporaneous if the contributor taxpayer obtains the acknowledgement on or before the earlier of (1) the date on which a taxpayer files a return for the taxable year in which the contribution is made, or the due date (including extensions) for filing such a return. The acknowledgment is a periodic statement reflecting information bearing card account balances and the like, in one embodiment.

The method also includes the optional step of a fund-raising organization providing substantiation of a contribution to a tax processing governmental body, e.g. the Internal Revenue Service, on a hard copy of a tax return or electronically. The substantiation and record thereof, includes, by way of example,

(1) The amount of cash, card information and numerical contribution amount contributed by a respective contributor, or a group of contributors;

(2) Whether the fund-raising organization provided any goods or services in consideration, in whole or in part, in exchange for the cash contributed; and,

(3) A description and good faith estimate of the value of any goods or services referred to in (2) above of, if such goods or services consist solely of intangible religious benefits a statement to that effect.

A contributor's computer, a fund-raiser's computer, a bank computer, or a combination thereof, on the network(s) optionally associate to respective contribution transaction(s), e.g. including respective card information and respective numerical contribution amount information for a single contributor or a plurality of contributors, with a designation regarding the tax deductibility status of the contribution transaction. By way of example, the status may include whether or not the contribution is or is not tax deductible, or whether the organization to which the contribution is falls under a certain category of taxable organization, or combination thereof.

The present invention provides a method of increasing the giving of contributions, a method of increasing the average size of a contribution given by an contributor, a method of increasing the average contribution given by an individual over a period of time, a method of increasing the contribution revenue of a fund-raising organization, a method of increasing the average contribution revenue of a fund-raising organization, a method of increasing the average giving of a contributor to a single fund-raising organization, of a plurality of fund-raising organizations. The methods described above include a contribution wherein the contribution is a fund-raising organization contribution, a political contribution, a religious organization contribution, a charitable contribution. The method steps are those as disclosed above.

A method of decreasing the average number of chargebacks associated with a group of transactions is also provided. The present invention also provides a system for fund raising, increasing fund-raising revenue, or combination thereof.

A method of maximizing the contribution potential of a group through the use of contributor computers on a network(s), a funds processing network, a card account processor, or combination thereof.

A group of people using their computers 107, 800-806 on computer network 301, 303, 305, 307, 309, 401 has a contribution potential denoted by the function “C(p)”. A contribution potential, C(p), is a function that symbolizes the amount of contributions that can theoretically be gathered from a group of contributors, e.g a first contributor, “contributor₁” to an nth contributor, “contributorₙ” on the network(s) 301, 303, 305, 307, 309, 401, or combination thereof, or, by way of another example, group of prospective contributors physically located together for a contribution session.

In mathematical terms C(p) is proportional to Iᵢ, C(p) is proportional to Mᵢ, C(p) is proportional to Pᵢ, C(p) is proportional to Gᵢ, C(p) is proportional to Cᵢ, C(p) is proportional to Nᵢ, C(p) is proportional to Xᵢ, and C(p) is proportional to Aᵢ. In these examples, 1≦i≦n.

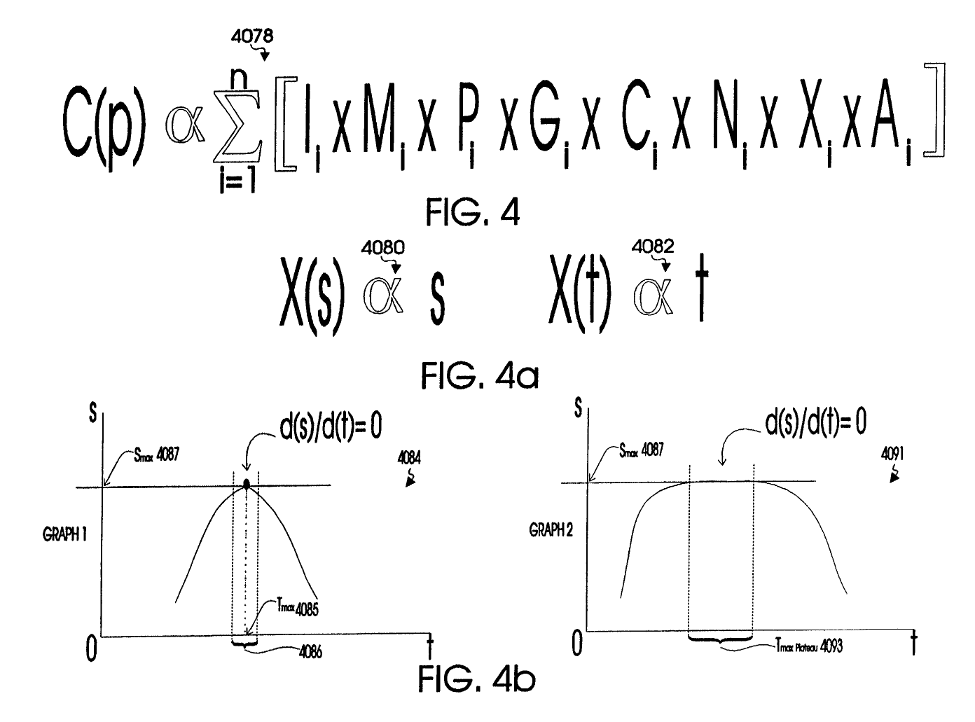

C(p) is also proportional to the sum from i=1 to i=n of the product of the function [Iᵢ*Mᵢ*Pᵢ*Gᵢ*Cᵢ*Nᵢ*Xᵢ*Aᵢ] 4078 as illustrated in FIG. 4.

As is understood, the contribution potential, C(p), of a group of contributors is a function of a variety of different variables.

The variable Iᵢ for a respective contributor is a function of the importance a cause or objective has to a specific contributor. By way of example, an ith contributor may place a high level of importance to contributions that are made to allow an individual to obtain an organ transplant, and a lower level of importance on contributions made to an organization that has as its goal the creation of a habitat to save an endangered species. It will be understood that a variant of the method of the present invention for maximizing the C(p) of a contributor, involves analyzing I for the respective contributor by calculating a historical affinity of the contributor for the cause being contributed to and then transmitting the email solicitation message thereto. This calculation is accomplished by utilizing known statistical techniques.

The variable Mᵢ is a function of the ease of making a contribution at the time and place where the contribution is solicited. Mᵢ is a function of, and is proportional to, the speed with which a contribution may be made denoted by Sᵢ, and a convenience variable denoted by Qᵢ. Mᵢ can be increased by the methods and system of the present invention.

Mᵢ is a function of the speed with which a contribution may be consummated. The shorter the length of time within which it takes to consummate a contribution by a respective contributor, the larger the Mᵢ variable. Hence, Mᵢ is inversely proportional to the speed within which a contribution can be consummated at the time it is solicited. As is understood C(p) will be increased for contributors if the amount of time that it takes for the respective contributors to consummate their respective contributions can be decreased. The methods provided herein increase the convenience and speed with which a contribution is made since a contributor need not leave to attend a fund-raising event, but may do so from the privacy of his home computer.

By way of example, the length of time it takes for contributors to make their respective contribution transactions is decreased if there is no request for authorization associated with contributions at the time the contribution is made on computer 107, 800-806. Preferably, there is no request for authorization correlated to contributions at, or about, the time and location where the contributions are being entered by contributors.

The variable Pᵢ is a function of the ability to consummate a contribution. In the scenario where cash is used as a contribution, Pᵢ is 1 since 100% of the contribution transactions are consummated at the time and location where the contribution is solicited. In the scenario where pledges are used to collect contributions, the Mᵢ may be very high since it is very easy to pledge a contribution amount, but Pᵢ is substantially less than 1 since consummating the contribution is far removed from the point in time and space from the application of external stimulus s by an email solicitation message or request. Moreover, a large percentage of the contributions that are pledged are not collected since the financial situation of the contributor changes, the contributor forgets about the pledge altogether, or the impulse that prompted the contributor to make the pledge dissipates and the contributor no longer has a psychological motivation to consummate the contribution transaction. Electronic mail messages or requests communicated to prospective contributor's computers 107, 800-806; fund-raiser's computer 103, 405; card account processor 1031; networks 310, 303, 305, 307, 309, 401; information bearing card indicia correlated to numerical contribution amounts; information representative of electronic currency; and combinations thereof, are used to consummate the contribution at, or about, the point of maximum stimulus.

Moreover, computers 107, 800-806, 103, 405, and data sets comprised of requests for inducing contributions presented at or near the time of the need for the contributions, e.g. at or near the time of a natural disaster, allow the impulse and the incitement to action arising by the state of mind of the contributor, or the collective state of mind of the group of contributors to be harnessed at the time the impulse or incitement to action is at or about its maximum level. For example, tens of thousands or prospective contributors are allowed to forward contributions at or near the time of a hurricane by use of the methods described herein to aid in disaster relief.

The contribution potential function, C(p), is also proportional to and a function of an impulse giving function denoted by X. The impulse giving function measures the level of incitement to action to make a contribution that arises from the creation of a state of mind by providing an external stimulus to a contributor or a group of contributors. A state of mind is created by the presentation of an external stimulus or stimuli. The stimulus is provided by a multimedia presentation on prospective contributors' respective computers 107, 800-806, and peripherals associated therewith.

The impulse giving function, X(s) is proportional to a stimulus variable, “s”. X(s) is also proportional to time variable, “t” 4082.

A graph, as illustrated in FIGS. 4b, has a point t₀ that indicates the start of a contribution session presented on computers 107, 800-806 (and related peripherals), e.g. an email request to make a contribution, and the start of the presentation of stimulus s₀ to a contributor or to a group of contributors. As t progresses forward (time goes forward), a stimulus or stimuli s is provided or presented to the contributors as indicated by an increasing value of the variable s.

The stimulus (s) is any external stimulus or stimuli that creates a state of mind conducive to the making of contributions presented on computers 107, 800-806 and peripherals associated therewith. By way of example, an external stimulus such as audio stimulus or a visual stimulus is presented to the group by way of their respective computers. Audio stimulus includes sound recordings, real time speeches by candidates, real time presentations by missionaries, and the like, that evoke an emotion conducive of contribution making, e.g. sympathy, anger, love, hate, a need for victory.

Video stimulus includes audio/visual presentations and “real time” presentations of scenes or people such as poverty stricken individuals in need of resources, individuals in need of nutrition, individuals in need of medical care or having a medical condition, and the like. The methods of the invention teach that presentation of strong external stimuli increases the value of the impulse giving function and thus increases the overall value of the contribution potential of the group or individual.

The impulse giving function X will reach a maximum value where d(s)/d(t)=0 4086, 4093 during the electronic solicitation of a contribution and presentation thereof and then decays over time. Hence, the more remote in time we get from the maximum value of the stimulus at tₘₐₓ, the lower the value of the impulse giving function becomes, and the lower the contribution potential and the impulse to contribute. The impulse giving potential of a group of contributors (and the contribution potential which is a function of the impulse giving potential of a group) decays and dissipates over time as we move further away from tₘₐₓ. Preferably, where d(s)/d(t)=0, or as close as possible thereto in time, a plurality of prospective contributors are given the ability to make and enter contributions on their respective home computers for communication onto computer networks, 301, 303, 305, 307, 309, 401, or combination thereof, and to fund-raiser's computer 107, 405, card account processor 1031, a bank, or combination thereof. This is the point where the maximum impulse level to make a contribution exists.

Access in time and space is provided by the prospective contributors' personal computers to capture the impulse to contribute. By way of example, respective contributors are at remote computers 107, 800-806 at or about the time of an event, e.g. a natural disaster, for which contributions are collected to provide relief to survivors.

That is, the methods disclosed herein facilitate impulse giving. A contribution is made and recorded, for post-processing, at the time, Tₘₐₓ, where the psychological stimulus, Sₘₐₓ, e.g. a rousing speech by a political candidate, government official, minister, fund-raiser, etc., is highest. Requests for contributions are electronically communicated to prospective contributors' computers 107, 800-806 at a point in time near a disaster or other event for which contributions are requested.

For example, in the variant of a natural disaster, C(p) is greatest at a point in time closest to the occurrence of the event. As time proceeds forward, C(p) decreases. Hence, requests are preferably communicated within several hours of the occurrence of the disaster, within days of the occurrence of the disaster, within weeks of the occurrence of the disaster.

The variable Xᵢ is the ability of a speaker, news event, or solicitor of a contribution to incite the group of contributors to action. The action includes the impulse giving of the group. The more charismatic the speaker or solicitor of contributions is, or more moving a news event is, the more likely a respective contributorₙ, or group 4000, will be to make a larger individual contribution or cumulative contributions. By way of example, a candidate for political office incites his supporters to consummate contribution transactions by a rousing speech presented on-line to prospective contributors on the network(s). The provision of the speech, or news event on-line to prospective contributors' computers harnesses the spontaneous impulse giving potential that is created by the incitement to action created by an external email stimulus presented on computers 107, 800-806, e.g. a speech, a moving motion picture, and other auditory or visual stimulus designed to evoke a psychological response, e.g. sympathy, anger, compassion, thanksgiving, contrition, etc. It is understood that computers 107, 800-806, 103, 405 optionally include multi-media hardware and software additions.

By way of example, display 840 on prospective contributors' computers 107, 800-806 prompts contributors make contributions to obtain a first wish list item for the fund-raising organization: “Any amount to a Scholarship fund to train students entering a worthwhile field” (not shown). The first prompt can be displayed concurrently with other prompts or may be displayed consecutively for a time out period on the display.

As illustrated on FIGS. 2 and 2a, a second prompt is displayed to a contributor soliciting a contribution for a second wish list item 4094: “$5.00—Needy Child Services—provides a needy child meals for one week.” A third message prompt 4096 is displayed to a contributor soliciting a contribution for a third wish list item: “$25.00—Hurricane Disaster Relief Service—buys 200 blankets for the victims of Hurricane Josephine.”

A fourth prompt 4100 is displayed to a contributor soliciting a contribution for a fourth fund raising organization wish list item: “$50.00—Newborn Services—buys 100 bottles of baby formula for newborns of poverty stricken infants in South America.”

A fifth prompt 4102 is displayed to a contributor soliciting a contribution for a fifth fund raising organization wish list item: “$1000.00—Incubators—buys 1 incubator that will save the lives of many infants in a Children's Hospital.”

It will be understood that the menu of wish list items will induce contributors to make contributions to specific wish list items. As each wish list item is correlated with a contribution, the wish list item may be removed from the group of wish list items displayed on the computer or interactive display in one variant. Alternately, the group of wish list items may continue to be displayed and the amount of wish list items which are correlated with contributions may be tallied. Moreover all contributions are routed to a single account, a running total is recorded of the number of specific “wish list” items for which contributions have been made so that latter the wish list items may be purchased according to the respective number of wish list items for which contributions have been given.

While only a few, preferred embodiments of the invention have been described hereinabove, those of ordinary skill in the art will recognize that the embodiment may be modified and altered without departing from the central spirit and scope of the invention. Thus, the preferred embodiment described hereinabove is to be considered in all respects as illustrative and not restrictive, the scope of the invention being indicated by the appended claims, rather than by the foregoing description, and all changes which come within the meaning and range of equivalency of the claims are intended to be embraced herein.

I claim:

1. A fund-raising computer network for simplifying and inducing the giving of monetary contributions by a multiplicity of remote prospective contributors comprising,
a first computer with communication circuitry that communicates data sets comprised of requests soliciting the making of monetary contributions onto a computer network for receipt by a plurality of remote prospective contributors' computers;
a communication link that communicatively links the first computer with a second computer; and,
a second computer with communication circuitry that receives data sets comprised of contributions communicated from the remote contributors' respective computers.

2. The fund-raising computer network of claim 1 further comprising means for encrypting and decoding the data packets comprised of contributions, whereby the data packets are encrypted for communication onto a computer network.

3. The fund-raising computer network of claim 1 in which said monetary contribution is a political contribution.

4. The fund-raising computer network of claim 1 in which said monetary contribution is a charitable contribution.

5. The fund-raising computer network of claim 1 in which said monetary contribution is a religious contribution.

6. The fund-raising computer network of claim 1 in which said request comprises a multi-media presentation.

7. The fund-raising computer network of claim 1 further comprising means for substantiating the respective contributors respective contributions.

8. The fund-raising computer network of claim 1 further comprising means for entering debits to accounts of contributors and entering credits to an account of a fund-raiser.

9. A method of simplifying and inducing the giving of monetary contributions by a multiplicity of remote prospective contributors comprising,
communicating onto a computer network for receipt by remote prospective contributors' computers data sets each comprised of requests soliciting the making of monetary contributions;
communicating onto a computer network by the remote contributor's computers data sets comprised of contributions responsive to the requests; and,
receiving the data sets comprised of contributions communicated from the remote contributors' computers.

10. The method of claim 9 further comprising the steps of encrypting the data sets comprised of contributions for communication onto the computer network, and decoding the encrypted data sets comprised of contributions at a remote computer.

11. The method of claim 9 further comprising the step of selectively presenting to the remote prospective contributors' computers recommended numerical contribution amounts correlated to the respective credit worthiness of the contributors.

12. The method of claim 9 in which said contribution is a political contribution.

13. The method of claim 9 in which said contribution is a charitable contribution.

14. The method of claim 9 in which said contribution is a religious contribution.

15. The method of claim 9 in which said request comprises a multi-media presentation.

16. The method of claim 9 further comprising the step of associating the communication of the data sets comprised of the requests to a natural disaster.

17. The method of claim 9 further comprising the steps of segregating groups of data sets comprised of contributions correlated to respective causes, temporarily storing the segregated groups, and communicating the respective segregated groups sequentially to another remote computer for further processing.

18. The method of claim 9 further comprising the step of transmitting data sets substantiating said contributions to the multiplicity of contributors' computers.

19. The method of claim 9 further comprising the step of decoupling requests for authorizations of the respective contributions when the contributions are entered onto the remote prospective contributors computers.

20. A method of facilitating and inducing the making of monetary contributions comprising,
communicating data sets comprised of wish list items to a plurality of remote fund-raising terminals; and,
receiving data sets comprised of contributions communicated from the plurality of remote fund-raising terminals.
